(19) United States
(12) Patent Application Publication
(10) Pub. No.: US 2022/0172304 A1
(43) Pub. Date: Jun. 2, 2022

(54) SYSTEM AND METHOD FOR REAL TIME SOCIAL ENGAGEMENT

(71) Applicant: Tran Woods, Irving, TX (US)

(72) Inventor: Tran Woods, Irving, TX (US)

(21) Appl. No.: 17/109,735

(22) Filed: Dec. 2, 2020

(51) Int. Cl. G06Q 50/00; G06Q 30/06; G06Q 30/08; G06Q 10/08; G06Q 20/38; G06F 16/23; H04L 29/06; H04L 12/58

(52) U.S. Cl. CPC G06Q 50/01; G06Q 30/0611; G06Q 30/08; G06Q 30/0633; H04L 51/32; G06Q 10/083; G06Q 20/384; G06F 16/2379; H04L 65/403; G06Q 30/0639

(57) ABSTRACT

Disclosed herein is a system and method for real time engagement between a plurality of users in a social set-up by means of an application software connected to a server. The application software enables a user to interact with other user numbers in real time. The method further enables a user to check-in to a business-member based on a real-time location of the user-member.

### TECHNICAL FIELD

This disclosure relates to generally to real time data processing systems and specifically to system and methods for real-time social engagement between a plurality of users at a social site.

### BACKGROUND

Socializing between unacquainted persons at a bar, club, restaurant, or other social location to create friends or other relationships often involves challenging, time-consuming, hit or miss in-person interactions. People are generally not aware of each other likes, dislikes and hence striking conversations and discussions may be challenging as well as awkward. This also hampers business of restaurants or bars, pubs.

Generally, people offer each other drinks or foods free of cost to initiate a discussion. However, offering and buying a drink or food to help with such interactions often causes more challenges and time loss. Furthermore, people might not be sure as to who are the people they would be willing to be associated and engaging with.

In light of above mentioned problem, there does not exist a solution that simplifies and saves time in such interactions by allowing the use of a computing device such as a mobile phone to search for and communicate with desirable acquaintances at local social locations and to increase real-time engagement between a plurality of users.

### SUMMARY

The present disclosure seeks to provide a system and method for real time engagement between a plurality of users in a social set-up by means of an application software connected to a server. The application software enables a user to interact with other user numbers in real time. The method further enables a user to check-in to a business-member based on a real-time location of the user-member.

Embodiments of the present disclosure substantially eliminate or at least partially address the aforementioned problems.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a block diagram of an example system according to the present disclosure.

FIG. 2 depicts a flowchart describing the method steps as per a preferred embodiment of the present invention.

It will be appreciated that the drawings illustrated herein are for representative purposes only and do not intend to limit the scope of the present disclosure, and actual implementation of the present disclosure may be viewed substantially differently.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

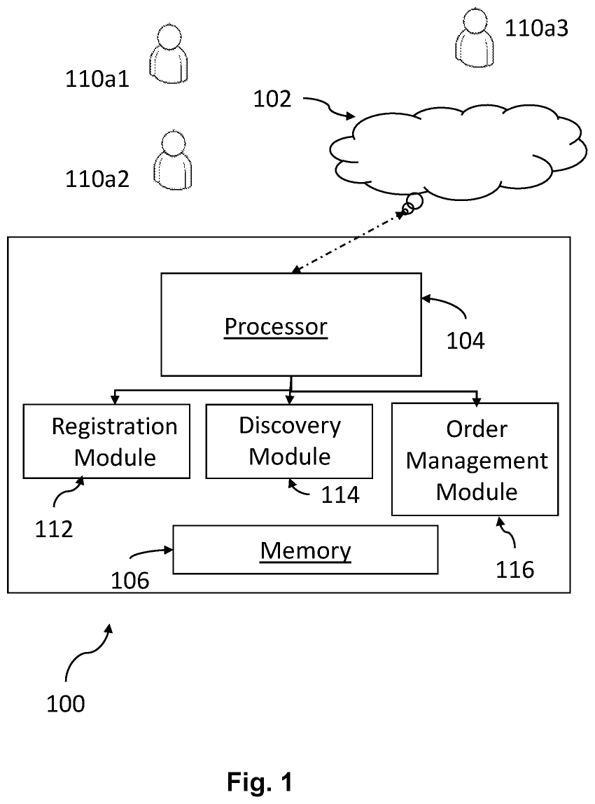

FIG. 1 illustrates a block diagram of an example system according to the present disclosure, for implementation of a system for social engagement 100 according to the present disclosure.

As shown in FIG. 1, in some implementations, the system 100 may include one or more client devices 110a1 (user-member), 110a2 (vendor-member), 110a3 (business-member) (collectively “client devices 110”), data communication network 120, and servers 102. In some implementations, the system 100 may also include one or more data storages linked to the server 102.

Client devices 110a1-a3 (collectively “client devices 110”) are depicted as a mobile phone 110a1-a3 and a desktop computer 110b1-b3, respectively, but client devices 110 may comprise any type of computing device, such as a desktop computer system, a laptop, cellular phone, a smart device, a mobile telephone, a tablet style computer, or any other device capable of wireless or wired communication. In some implementations, client devices 110 are configured to interact with the server 102 via an application, such as a web browser or a native application, residing on the client device 110.

In some implementations, the client devices 110 include hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the system 100 or any other component suitable for a particular purpose.

In some implementations, the client devices 110 are configured to access networks 120. In some implementations, the client devices 110 are configured to communicate with server 102.

In some implementations, components of the system 100 may communicate with any other component of the system 100 over network 120. Network 120 may be any suitable network. In some implementations, for example, one or more portions of network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 120, or a combination of two or more of the foregoing.

In some implementations, the server 102 may include a processor, memory, user accounts, and one or more modules to perform various functions such as those described above.

In some implementations, the server 102 may be a unitary server or may be a distributed server spanning multiple computers or multiple datacenters. Servers 102 may be of various types, such as, for example and without limitation, web server, file server, application server, exchange server, database server, or proxy server. In some implementations, the server 102 may include hardware, software, or embedded logic components or a combination of two or more such components for carrying out the appropriate functionalities implemented or supported by server 102. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

The system 100 comprises a processor 104 communicably coupled with the server 102 wherein the processor 104 is configured to operate a registration module 112, a discovery module 114 and an order management module 116.

In an embodiment, the processor 104 is operable to register, via the registration module 112, a plurality of entities with the server via an application software. The application software may be operated from a client device with a graphical user interface. In an example embodiment, said client devices include smartphones, desktop computer, tabs etc.

In the preferred embodiment, the plurality of entities registered with the server are one of a user-member, a business-member, and a vendor-member. The user-member refers to one or more individuals who visit a social site such as restaurant, bar, pub or any other social set-up. The business-member refer to said social sites such as restaurant, bar, pub or any other social set-up operating as a commercial entity. Each business-member is associated with a site location wherein said site-location is a physical address. Optionally, the site location can be a virtual platform with an IP address. The vendor-members are individuals or groups offering at least one service, for the user-members, at a site-location of a business-member. Example of such vendor-members are music bands, artists, stand-up comedians etc.

The processor 104 is configured to receive, while registering the user-member, a user meta-information and a set of pre-defined authorizations from each of the registered user-member wherein the user meta-information comprises name, user_id, registered address, contact information, pre-stored preferences and bank payment credentials. The user meta-information is used to distinctly identify a user by the server 102. The set of pre-defined authorizations comprises an access to present location of the user, access to media gallery on the client device associated with the user-member and authorization to enable bank transactions on behalf of user-member. In an embodiment, pre-stored preferences include outing preferences relate to one of a bar, pub and restaurant, antique themes, historical places, fine-dining to name a few. The processor 104 is configured to create a user profile based on received user meta-information wherein the user profile comprises information on the user-member, set of active pre-defined authorizations and a real-time location of the user-member. The user-profile further comprises a list of acquaintances of the user-member marked as friends by the user-member wherein the acquaintances marked as friends are other user-members registered with the server. Furthermore, the processor 104 enables a user member to perform a search, though the graphical user interface, for other user-members based on user_id or on based on name of other user members.

The processor 104 is configured to receive, while registering the business-member, a business meta-information from each of the registered business-member wherein the business meta-information comprises name, a registered address, list of offerings, service menu, time of service etc.

The processor 104 is further configured to receive, while registering the vendor-member, a vendor meta-information from each of the registered vendor-member wherein the vendor meta-information comprises name, a registered address, list of offerings, time of service etc.

In an aspect of the present invention, the processor 104 is configured to identify, via a discovery module 114, at least one business-member to be visited by a user-member based partly on a matching factor, a real-time location of said user-member and acquaintances of said user-member registered as friends, and one or more offers provided by a business-member. The discovery module 114 is able to identify at least one business-member which could be visited by the user-member amongst all the business members, thereby facilitating decision by the user-member. The processor 104 uses a real-time location of the user-member in identifying the most probable place of visit i.e. the business-member by the user-member. One or more business-members falling within a fixed distance radius from the real-time location of the user-member are selected by the processor. Optionally, the fixed distance radius is selected by the user-member on a graphical user interface of the application software. In an example embodiment, the fixed distance radius selected by the user is 5 km. Alternatively, it could be 10 km. In an embodiment, the selection of fixed distance radius is implemented by means of a slider selected by the user-member on the graphical user interface, Optionally, the same can be a text input field. Optionally, alternatively, the fixed distance radius is pre-selected by the application software.

Further, the processor 104 identifies though the discovery 114 module in communication with the server 102, a real-time location of one or more friends of the user-member. The processor 104 utilizes information of real-time location of friends of the user-member in order to identify a probable place of visit by the user-member.

Furthermore, the processor 104 calculates a matching factor wherein the matching factor is based on pre-stored preferences of the user member and a satisfaction score based on prior visits of the user-member to the business member site. As described in the foregoing paragraphs, the pre-stored preferences relate to outing preferences of the user-member. The pre-stored preferences are retrieved from the user profile of the user-member by the processor 104. The satisfaction score is one of a review score assigned by the user-member to a business-member based on prior visit and the same is based on experience of the user-member. In an example embodiment, the satisfaction score is a numeric score based on a scale of 1-100.

As per an example embodiment, a user-member with an outing preference of fine-dining has a satisfaction score of 90+, based on prior visits, for a business-member offering fine-dining services. Said business-member will have a higher matching score calculated by the processor 104.

Moreover, the processor 104 is further operable to identify a business-member to be visited by the user-member based on one or more offers provided by the business-member. In some examples cases, a business-member offering a 50% discount on its service menu can be a most probable visit site. Optionally, performance by one or more vendor-members on a business-member site could be another factor in deciding the business-member to be visited by the user-member.

The processor 104, based on all above-mentioned factors, identifies the at least one business-member to be visited by a user-member based on weighted score calculated based on matching factor, a real-time location of the user-member and friends of the user-member as well as the one or more offers provided by the business member.

In an embodiment of the present invention, the processor 104 is further configured to sort one or more business-members based on the weighted score for each of the business-member.

In yet another aspect of the present invention, the user-member is enabled to check-in on a business-member visited by the user-member on the graphical user interface of the client device of the user-member. A check-in can be interpreted as actual visit to a site location of a business-member and means that the user-member is present on the site-location of the business-member. The processor 104 is configured to record, with the server, a visit of the user-member to a site location of the business-member, along with a time-stamp, based on a real-time check-in by the user-member. Optionally, the processor 104 is operable to validate, with the server 102, a real-time check-in by the user-member by matching a real-time location of the user-member with the location of business-member i.e. registered address of the business-member. In an alternate embodiment, the processor 104 may enable a user-member to check-in virtually without physically visiting the site location of the business-member. Similar to the processing as described above, the server 102 stores a list of recorded check-in by a plurality of user-members at corresponding business-members site locations along with a time-stamp. Further, the processor 104 is operable to record, with the server 102, a check-out by one or more user-member though the graphical user interface of the client device wherein check-out denotes the user-member physically leaving the site location of the business-member where the user-member had checked-in. The check-out is recorded along with a timestamp and the list of recorded check-in is updated at the server 102.

In yet another aspect, the processor 104, via an order management module 116 communicably coupled to the server 102, is configured to display on the graphical user interface of the client device associated with the user member, a list of one or more offer transactions with other user-members with recorded check-in at the business member wherein the one or more offer transactions comprises either of sent or received offers to and from other user-members.

In an embodiment, a user-member visiting a business member, either physically or remotely, is enabled, via the application software in communication with the server, to engage with other user-members who are present in the site location of the business-member, either physically or remotely, by means of one or more offer transactions.

In an aspect of the present invention, the processor 104, in communication with the server 102, is configured to display a list of other user-members with recorded check-ins at the site location of the business-member being visited by the user-member. Said list of other user-members with recorded check-ins at the site location of the business-member being visited by the user-member is updated in real-time at the server 102 based on checkout by other user-members and the updated list is displayed by the processor 104 on the graphical user interface of the client device of the user-member. Further, each user-member in the said list has a user profile associated with it that can be viewed by the user-member. Moreover, the processor 104 enables the user-member to designate, through the graphical user interface of the client device of the user-member, one or more other user-member as acquaintances in terms of “friends” added to the user-member's user profile.

The user-member is enabled by the processor 104, via the order management module in communication with the server, to send or receive one or more offer transactions to the other user-members with recorded check-ins at the site location of the business-member being visited by the user-member. Throughout this disclosure, the term “offer transaction” refers to one or more goods or services offered at business-member. As an example, if the business-member is a restaurant, the offer transaction can be a dish or drink available on service menu of the restaurant. Similarly, if the business-member is a casino, a set of poker-chips could be an offer transaction. Furthermore, if a vendor-member is performing at the site location of a given business-member, the offer transaction can be proposing a dedicated performance for other user-member. The offer transaction shall have a sender and a recipient.

In an aspect of the present invention, the offer transactions sent by the user member to the other user-members with recorded check-ins at the business-member are either of a custom offer or a broadcast offer. The processor 104 allows the user-member, though the order management module, to send a custom offer to one or more selected other user-members with recorded check-in at the business member. The one or more other user-members to whom an offer transaction can be sent are selected by the user based on review of the user profile of other user-members. Further, the user-member is enabled to select one or more items that constitute the offer transaction for each of the selected user-member. Therefore, it shall be appreciated by person skilled in the art that custom offer allows a varied permutation of items and user-members to be selected. In case of the broadcast offer, the offer transaction is sent, simultaneously, to all other user-members with recorded check-in at the business-member. In an example embodiment, said broadcast offer transaction can be “I am buying”. In another example embodiment, said broadcast offer transaction can be “I am buying Tequila” without specifying any particular user-member.

The processor 104 is operable to display a list of offer transactions sent, by the user-member, to other user-members with recorded check-ins at the business-member. Optionally, the processor 104 is operable to display a status of said offer transactions sent, by the user-member, to other user-members with recorded check-ins at the business-member. As per the preferred embodiment of the present invention, the offer transaction can be accepted by other user-member to whom said offer transaction is sent. Alternatively, it might be rejected or may be pending for acceptance. Furthermore, the processor 104, via the order management module 116 in communication with the server, is operable to update the list of said offer transactions sent, by the user-member, to other user-members based on check-out of by said other user-members based on check-outs recorded from other user-members. In case one of the other user-member, to whom an offer transaction has been sent, checks-out, said offer transactions will be removed from the list of offer transactions sent.

In another embodiment, the processor 104 is operable to display a list of one or more offer transactions received, by the user-member, by other user-members with recorded check-ins at the business-member. Said received one or more offer transactions are either one of a custom offer or a broadcast offer. The processor 104 is further configured to display a user profile of the other user-member who has sent the offer transaction to the user-member. Optionally, the processor 104 is operable to display a status of said one or more offer transactions received, by the user-member, by other user-members with recorded check-ins at the business-member. As per the preferred embodiment of the present invention, an offer transaction can be accepted by the user-member. Alternatively, it might be denied or may be pending for acceptance.

In another aspect of the present invention, the processor 104 is configured to process one of the offer transactions, either sent or received, based on an acceptance and rejection status of the offer transaction wherein the processing the offer transaction includes implementation of the offer transaction and an execution of payment associated with the offer transaction. In case of an offer transaction sent by the user-member is accepted by other user-member, the processor 104 is configured to update the business-member about implementation of said offer transaction. As an example, an offer of drink by the user-member to another user-member may be accepted by the other user-member. The processor 104 then updates the business-member of said acceptance which then sends the drink to the other user-member who accepted the offer transaction. The processor 104 is further configured to charge a bank account associated with the user-member for the cost of the offer transaction. Said charge on the bank account may be effected though one or more digital payment means in real-time or credited to a ledger maintained with the user profile of the user-member. Alternatively, in case of an acceptance of offer transaction by the user-member, the user-member is served with the offer transaction by the business-member.

Optionally, an offer transaction can be placed by the user-member to the business-member for purchase, by the user-member, of one or more gods or services for itself from the business-member or a vendor-member. In said case, the sender and recipient of offer transaction are one and the same i.e. the user-member. The processor 104 is configured to update the business-member about implementation of said offer transaction and process said offer transaction for the user-member.

In yet another embodiment of the present invention, the processor 104 is further configured to update the business-member of the acceptance of an offer transaction and enable the business-member to deliver the offer transaction at said user-member's registered address as per the corresponding user profile, wherein delivering the offer transaction shall mean implementation of offer i.e. delivery of goods or performance of service at the registered address of the user-member who accepted said offer transaction.

In yet another embodiment, the processor 104 is configured to enable the user-member to transfer money to the one or more selected other user-members, business-member or a vendor-member. The processor 104 is enabled to charge a bank account associated with the user-member for said transfer of money. Said transfer of money is effected through one or more digital payment gateways or through peer-to-peer based transfer mediums. The user-member is enabled to transfer money to other user-members based on their discretion or needs. Further, the user-member may transfer money to the business-member for one or more services or goods. Similarly, the user-member may transfer money to one or more vendor-member as a cost of enjoying their services or as a tip for their performance.

In another embodiment, of the present invention, the processor 104 is further configured to allow the user member to engage with other user-members though real-time online media sharing through the graphical user interface of the application software. This includes sending and/or receiving one or more videos to other user-members registered with recorded check-ins. Optionally, media sharing can be done with other user-members who have checked-out as well. In an embodiment, the processor 104 is operable to allow a user-member to post a video to a business-member profile page accessible by all other user-members. Alternatively, the processor 104 is configured to allow the user-member to record, share and post live videos based on pre-defined authorizations of cameras of client device associated with the user-member.

In another embodiment of the present invention, the processor 104 is further configured to allow the user-member to engage with other user-members though one or more live private and/or public chat rooms. Said live private chat-rooms or live public chat-rooms are hosted through the server and one or more user-members are enabled to join the same through their application software. The live private chat-rooms or the live public chat rooms, as the case may be, allows user-members to share, post their discussions, media, music with one another in real-time. The live private chat-room can be formed with a few selected user-members amongst themselves with only selected user-members allowed to join the chat-room whereas a live public chat-room may be started by a business-member or by another user-member with all other user-members allowed to join the same.

In some implementations, the application software comprises a mobile application for a portable computing device, such as a mobile phone. In some implementations, the application software may also comprise a software application for a desktop computing device, such as a desktop computer. In some implementations, the software application for the desktop computing device may comprise the same or similar features as the mobile application for the portable computing device as described herein.

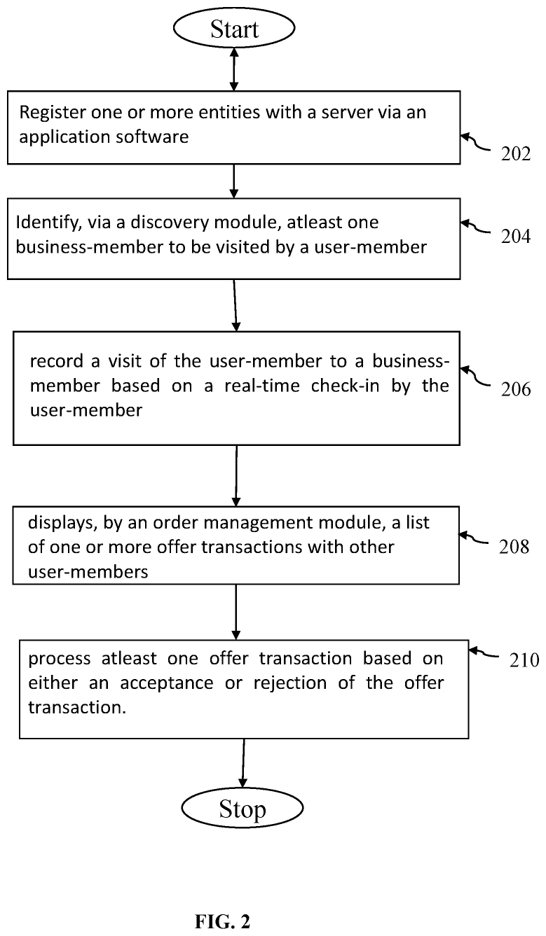

FIG. 2 depicts a flowchart describing the method steps as per a preferred embodiment of the present invention. At step 202, the processor 104 registers one or more entities with a server 102 via an application software. At step 204, the processor 104 identifies via a discovery module, at least one business-member to be visited by a user-member. At step 206, the processor 104 record a visit of the user-member to a business-member based on a real-time check-in by the user-member. Further at step 208, the processor 104 displays, by an order management module, a list of one or more offer transactions with other user-members. At step 210, the processor 104 processes at least one offer transaction based on either an acceptance or rejection of the offer transaction.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Additional modules can be included without deviating from the novel art of this disclosure. In addition, each module can include any number and combination of sub-modules, and systems, implemented with any combination of hardware and/or software modules.

Method steps of the invention may be performed by one or more computer processors executing a program tangibly embodied on a computer-readable medium to perform functions of the invention by operating on input and generating output. Suitable processors include, by way of example, both general and special purpose microprocessors. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

1. A method of real-time social engagement comprising:
registering, via a registration module, one or more entities with a server via an application software, wherein each of the one or more entities is registered as one of a user-member, business-member and vendor-member;
identifying, via a discovery module, at least one business-member to be visited by a user-member based partly on a matching factor, a real-time location of said user-member and acquaintances of said user-member registered as friends, and one or more offers provided by a business-member;
recording a visit of the user-member to a business-member based on a real-time check-in by the user-member;
displaying, by an order management module on a graphical user interface of a client device associated with the user member, a list of one or more offer transactions with other user-members with recorded check-in at the business member wherein the one or more offer transactions comprises either of sent or received offers to and from other user-members;
processing at least one offer transaction based on either an acceptance or rejection of the offer transaction.

2. The method of claim 1 wherein the one or more offer transaction of sent offers to other user-members comprises either of a custom offer or a broadcast offer.

3. The method of claim 2 wherein the custom offer is sent to one or more selected other user-members with recorded check-in at the business member site and wherein the broadcast offer is sent to all other members with recorded check-in at the site location of business-member.

4. The method of claim 1 wherein the order management module is configured to display a status of the one or more offer transactions.

5. The method of claim 1 wherein the user member is enabled to accept one or more offer transactions that are received through the order management module.

6. The method of claim 1 wherein processing at least one offer transaction comprises delivering an offer to a user-member, who has accepted an offer transaction, at said user-member's registered address.

7. The method of claim 1 further comprising allowing user members to engage with other user-members though real-time online media sharing through the application software.

8. The method of claim 1 further comprising user members to engage with other user-members though one or more live private and/or public chat rooms.

9. The method of claim 1 further comprising enabling a user-member to transfer money to the one or more selected other user-members, business member or a vendor-member.

10. The method of claim 1 wherein the matching factor is based on pre-stored preferences of the user member and a satisfaction score based on prior visits of the user-member to the business member site.

11. A system for real-time social engagement comprising:
a server:
a processor communicably coupled to the server;
a memory containing executable non-transitory machine readable instructions configured to instruct the processor to:
register, via a registration module, a plurality of entities with a server via an application software, wherein each of the plurality of entities is registered as one of a user-member, business-member and vendor-member;
identify, via a discovery module, at least one business-member to be visited by a user-member based partly on a matching factor, a real-time location of said user-member and acquaintances of said user-member registered as friends, and one or more offers provided by a business-member;
record a visit of the user-member to a business-member based on a real-time check-in by the user-member;
display, by an order management module on a graphical user interface of a client device associated with the user member, a list of one or more offer transactions with other user-members with recorded check-in at the business member wherein the one or more offer transactions comprises either of sent or received offers to and from other user-members;
process at least one offer transaction based on either an acceptance or rejection of the offer transaction.

12. The system of claim 11 wherein the one or more offer transaction of sent offers to other user-members comprises either of a custom offer or a broadcast offer.

13. The system of claim 11 wherein the custom offer is sent to one or more selected other user-members with recorded check-in at the business member site and wherein the broadcast offer is sent to all other members with recorded check-in at the business member site.

14. The system of claim 11 wherein the processor is further configured to display, via the order management module, a status of the one or more offer transactions.

15. The system of claim 11 wherein the processor is further configured to enable a user member to accept one or more offer transactions that are received through the order management module.

16. The system of claim 11 wherein processing at least one offer transaction comprises delivering an offer to a user-member, who has accepted an offer transaction, at said user-member's registered address.

17. The system of claim 11 wherein the processor is further configured to allow user members to engage with other user-members though real-time online media sharing through the application software.

18. The system of claim 11 wherein the processor is further configured to allow user members to engage with other user-members though one or more live private and/or public chat rooms.

19. The system of claim 11 wherein the processor is further configured to enable a user-member to transfer money to the one or more selected other user-members, business member or a vendor-member.

20. The system of claim 11 wherein the matching factor is based on pre-stored preferences of the user member and a satisfaction score based on prior visits of the user-member to the business member site.
